(19) United States
(12) Patent Application Publication
(10) Pub. No.: US 2017/0089692 A1
(43) Pub. Date: Mar. 30, 2017

(54) MONITORING OF GAUGES

(71) Applicants: Rita Chattopadhyay, Chandler, AZ (US); Anne M. Russell, Cedar Park, TX (US); David M. Bayba, Chandler, AZ (US); Gary Godding, Chandler, AZ (US)

(72) Inventors: Rita Chattopadhyay, Chandler, AZ (US); Anne M. Russell, Cedar Park, TX (US); David M. Bayba, Chandler, AZ (US); Gary Godding, Chandler, AZ (US)

(21) Appl. No.: 14/864,635

(22) Filed: Sep. 24, 2015

(51) Int. Cl. G01B 11/26; G01D 18/00; G01D 13/22; G06K 9/00; G06K 9/78

(52) U.S. Cl. CPC G01B 11/26; G06K 9/00771; G06K 9/78; G01D 13/22; G01D 18/00

(57) ABSTRACT

Methods, systems, and storage media for monitoring a gauge are disclosed herein. In an embodiment, an image processing module may receive a digital image of a gauge to identify an analog value indicator of the gauge and to form an indicator representation corresponding to the analog value indicator. A geometric analysis module may determine from the indicator representation a geometric characteristic corresponding to the analog value indicator and an indicated gauge value. Other embodiments may be disclosed and/or claimed.

### FIELD

The present disclosure relates to the field of Internet of Things (“IoT”), and in particular, to apparatuses, methods and storage media associated with monitoring of gauges.

### BACKGROUND

The Internet of Things (“IoT”) is a network of objects or “things”, each of which is embedded with hardware or software that enable connectivity to the Internet. An object, device, sensor, or “thing” (also referred to as an “IoT device”) that is connected to a network typically provides information to a manufacturer, operator, or other connected devices or clients in order to track information from or about the object or to obtain or provide services. IoT devices are deployed in homes, offices, manufacturing facilities, and the natural environment.

Conventional analog gauges, sometimes referred to as analog instrument meters with analog displays, typically have a gauge face with an analog value indicator such as a needle or pointer that pivots about a calibrated scale to provide an analog value indication. Analog gauges can have other configurations as well, such as linear pressure or temperature gauges (e.g., thermometers). Such gauges are used widely in science, industry, shipping, etc., in a wide range of situations including factories, mills, power plants, pipelines, etc. on various types of equipment, vehicles, vessels, etc. Analog gauges are monitored by human visual observation which, for a gauge in a remote or inconvenient location, can require significant time, effort, or expense and can even pose varying degrees exposure to or risk of injury. Some analog gauges have been replaced by gauges that function as IoT devices that communicate gauge value information automatically. However, with the vast installed base of existing analog gauges, human visual observation is still required.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a communications network in which various example embodiments described in the present disclosure may be implemented;

FIG. 2 illustrates an analog gauge and an adjacent digital camera;

FIG. 3 illustrates an example gauge monitoring apparatus or system;

FIGS. 4A-4E illustrate example process images and image processes, in accordance with various embodiments; and

FIG. 5 illustrates a flowchart of an example gauge monitoring process.

### DETAILED DESCRIPTION

In the following detailed description, reference is made to the accompanying drawings which form a part hereof wherein like numerals designate like parts throughout, and in which is shown by way of illustrated embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed to imply that the various operations are necessarily order-dependent. In particular, these operations might not be performed in the order of presentation. Operations described may be performed in a different order than the described embodiments. Various additional operations might be performed, or described operations might be omitted in additional embodiments.

The description may use the phrases “in an embodiment”, “in an implementation”, or in “embodiments” or “implementations”, which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include any or any combination of an Application Specific Integrated Circuit (ASIC), an electronic circuit, a processor (shared, dedicated, or group) or memory (shared, dedicated, or group) that execute one or more software or firmware programs, a combinational logic circuit, or other suitable components that provide the described functionality.

Also, it is noted that example embodiments may be described as a process depicted with a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in a figure. A process may correspond to a method, a function, a procedure, a subroutine, a subprogram, and the like. When a process corresponds to a function, its termination may correspond to a return of the function to the calling function a main function.

As disclosed herein, the term “memory” may represent one or more hardware devices for storing data, including random access memory (RAM), magnetic RAM, core memory, read only memory (ROM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and the like.

As used herein, the term “network element”, may be considered synonymous to or referred to as a networked computer, networking hardware, network equipment, router, switch, hub, bridge, gateway, or other like device. The term “network element” may describe a physical computing device of a network with wired or wireless communication links. Furthermore, the term “network element” may describe equipment that provides radio baseband functions for data or voice connectivity between a network and one or more users.

Example embodiments disclosed herein include systems and methods relating to reading of analog gauges. Some of the analog gauges, including the camera performing the reading may be “Internet of Things” (IoT) devices. It should be noted that objects, sensors, or other like devices that are part of the IoT may be referred to as “IoT devices”, “smart objects”, “smart devices”, and the like. The IoT is a network of objects that are embedded with hardware and software components that enable the objects to communicate over a communications network (e.g., the Internet). Because the IoT devices are enabled to communicate over a network, the IoT devices may exchange event-based data with service providers in order to enhance or complement the services provided by the service providers. These IoT devices are typically able to transmit data autonomously or with little to no user intervention.

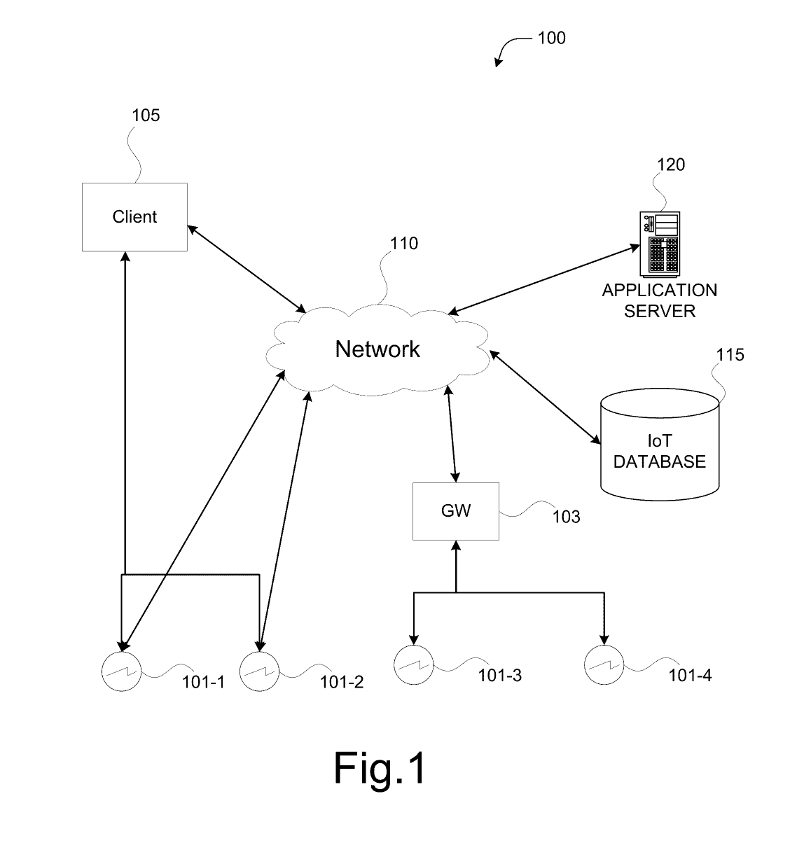

FIG. 1 shows a communications network 100 in accordance with various embodiments as an operating environment. As shown in FIG. 1, communications network 100 may include devices 101-1 to 101-4 (collectively referred to as “ devices 101”), gateway (GW) 103, client device 105, network 110, IoT database 115, and application server 120, coupled with each other as shown. Devices 101 may include non-IoT devices and IoT devices, in particular, a number of analog gauges, some of which may be non-IoT devices, while others are IoT devices. Further, devices 101 may include at least one camera, which may be an IoT device. As will be described in more detail below (with references to the remaining Figures), the at least one camera may be employed to facilitate automated reading of the analog gauges regardless whether they are standalone or having been embedded into an IoT device.

IoT devices 101 may be any object, device, sensor, or “thing” that is embedded with hardware and/or software components that enable the object, device, sensor, or “thing” to communicate with another device (e.g., client device 105, application server 120, another IoT device 101, etc.) over a network (e.g., network 110) with little or no user intervention. In this regard, IoT devices 101 may include a transmitter/receiver (or alternatively, a transceiver), one or more memory devices, and/or one or more processors. Furthermore, IoT devices 101 may be embedded with or otherwise include a transmitter or other like device that broadcasts an identification signal. In various embodiments, the identification signal may be a radio-based signal, such as a Wi-Fi signal, Bluetooth Low Energy (BLE) signal, an active radio-frequency identification (RFID) signal, an infrared signal, and the like.

According to various embodiments, the identification signal may comprise one or more data packets or data frames, where the data packets or data frames include a unique identifier associated with the IoT device 101 transmitting the identification signal. In various embodiments, the unique identifier (or alternatively, “identifier” or “identification information”) may include a universally unique identifier (UUID), an electronic product code (EPC), a media access control address (MAC address), an Internet Protocol (IP) address, an Apache QPID address, and/or any other like identification information.

In addition to analog gauges and camera, devices 101 may be other sensors, meters, or other like devices that can capture and/or record data associated with an event. For instance, in various embodiments, Devices 101 may be biotic sensors and/or devices, such as monitoring implants, biosensors, biochips, and the like. Additionally, IoT devices 101 may be abiotic sensors and/or devices, such as autonomous sensors and/or meters, Machine Type Communications (MTC) devices, machine to machine (M2M) devices, and the like. An event may be any occurrence of an action, such as a temperature change, an electrical output, a change in water usage, an inventory level/amount change, a heart rate, a glucose level, a state/position/orientation change of a device, and the like. In various embodiments, an event may be detected by one or more IoT devices based on sensor outputs, timer values, user actions, and reported as messages to a computing device, and the like.

Once data associated with an event is captured and recorded by an IoT device 101 (e.g., the at least one camera reading the analog gauges), the captured data may be relayed through the network 110 and reported to a service provider (e.g., an operator of the application server 120), a client device 105, and/or another one of the IoT devices 101. The service provider, a user of the client device or the client device itself, and/or IoT device may take an appropriate action based on a notification of the event to (e.g., reduce or increase temperature, restock inventory items, reduce/increase an activity level, reduce/increase sugar intake, and the like). In various embodiments, an IoT device 101 may connect with or otherwise communicate with the client device 105 via a direct wireless connection. In such embodiments, the data associated with an event may be reported to the client device 105 without being relayed through the network 110. It should be noted that the IoT devices 101 may be configured to report data on a period or cyclical basis, or based on a desired event that is captured and recorded by an IoT device 101.

In various embodiments, some of the devices 101 may include one or more electro-mechanical components which allow these devices 101 to change their states, positions, and/or orientations. These electro-mechanical components may include one or more motors, actuators, wheels, thrusters, propellers, claws, clamps, hooks, and/or other like electro-mechanical components. In such embodiments, the devices 101 may be configured to change their states, positions, and/or orientations based on one or more captured events and/or instructions or control signals received from a service provider (e.g., an operator of the application server 120) and/or client device 105. In various embodiments, an operator may receive, from one or more IoT devices 101, data associated with a captured event and physically control the IoT devices 101 by transmitting instructions or other like control signals to the IoT devices 101.

GW 103 may be a network element configured to provide communication services to IoT devices (e.g., some of IoT devices 101) and/or client devices (e.g., client device 105) operating within a computer network (e.g., an enterprise private network, virtual private network, local area network (LAN), a virtual local area network (VLAN), and/or any other like computer network). The GW 103 may be a wired or wireless access point, a router, a switch, a hub, and/or any other like network device that allows computing devices to connect to a network.

The GW 103 may include one or more processors, a network interface, one or more transmitters/receivers connected to one or more antennas, and a computer readable medium. The one or more transmitters/receivers may be configured to transmit/receive data signals to/from one or more IoT devices 101 and/or client device 105. The GW 103 may process and/or route data packets according to one or more communications protocols, such as Ethernet, Point-to-Point Protocol (PPP), High Level Data Link Control (HDLC), Internet Protocol version 4 (IPv4), Internet Protocol version 6 (IPv6), and/or any other like protocols. The GW 103 may employ one or more network interfaces in order to allow IoT devices 101 and/or client device 105 to connect to network 110, such as Ethernet, Fibre Channel, G.hn or ITU-T, 802.11 or Wi-Fi, Bluetooth, and/or any other like network connection interfaces.

According to various embodiments, the GW 103 may act as a central hub for one or more IoT devices 101 (e.g., IoT device 101-3 and IoT device 101-4 as shown in FIG. 1). In such embodiments, GW 103 may be a part of a private IoT network that is operated by a single service provider, IoT device manufacturer, and/or any other like entity. In embodiments where GW 103 is a hub for IoT devices 101 that are included in a private IoT network, GW 103 may connect the IoT devices 101 in the private IoT network to the network 110 and/or client device 105. As shown in FIG. 1, GW 105 is connected to IoT devices 101-3 and 101-4, and thus, GW 103 may enable IoT devices 101-3 and 101-4 to provide services or information to client device 105 via network 110. However, in various embodiments client device 105 may directly connect with GW 103, such that GW 103 may enable IoT devices 101-3 and 101-4 to provide services or information to client device 105 via the direct connection.

Network 110 may be any network that allows computers to exchange data. Network 110 may include one or more network elements (not shown) capable of physically or logically connecting computers. The network 110 may include any appropriate network, including an intranet, the Internet, a cellular network, a local area network (LAN), a personal network or any other such network or combination thereof. Components used for such a system can depend at least in part upon the type of network and/or environment selected. Protocols and components for communicating via such a network are well known and will not be discussed herein in detail. Communication over the network may be enabled by wired or wireless connections, and combinations thereof.

Device database 115 may be a hardware device or system for storing information for a plurality of devices. Device database 115 may include one or more relational database management systems (RDBMS) one or more object database management systems (ODBMS), a column-oriented DBMS, correlation database DBMS, and the like. According to various example embodiments, the device database 115 may be stored on or otherwise associated with one or more data storage devices. These data storage devices may include at least one of a primary storage device, a secondary storage device, a tertiary storage device, a non-linear storage device, and/or other like data storage devices. In some embodiments, device database 115 may be associated with one or more network elements that enable one or more clients (e.g., client device 105) to query the device database 115 and/or store device information in or retrieve device information from the device database 115. Furthermore, device database 115 may include one or more virtual machines, such that the physical data storage devices containing the device database 115 may be logically divided into multiple virtual data storage devices and/or databases. Alternatively, the device database 115 may reside on one physical hardware data storage device. In various example embodiments, the device database 115 may be the Object Naming Service (ONS), which provides product descriptions (i.e., indicators) for devices that are embedded with RFID tags.

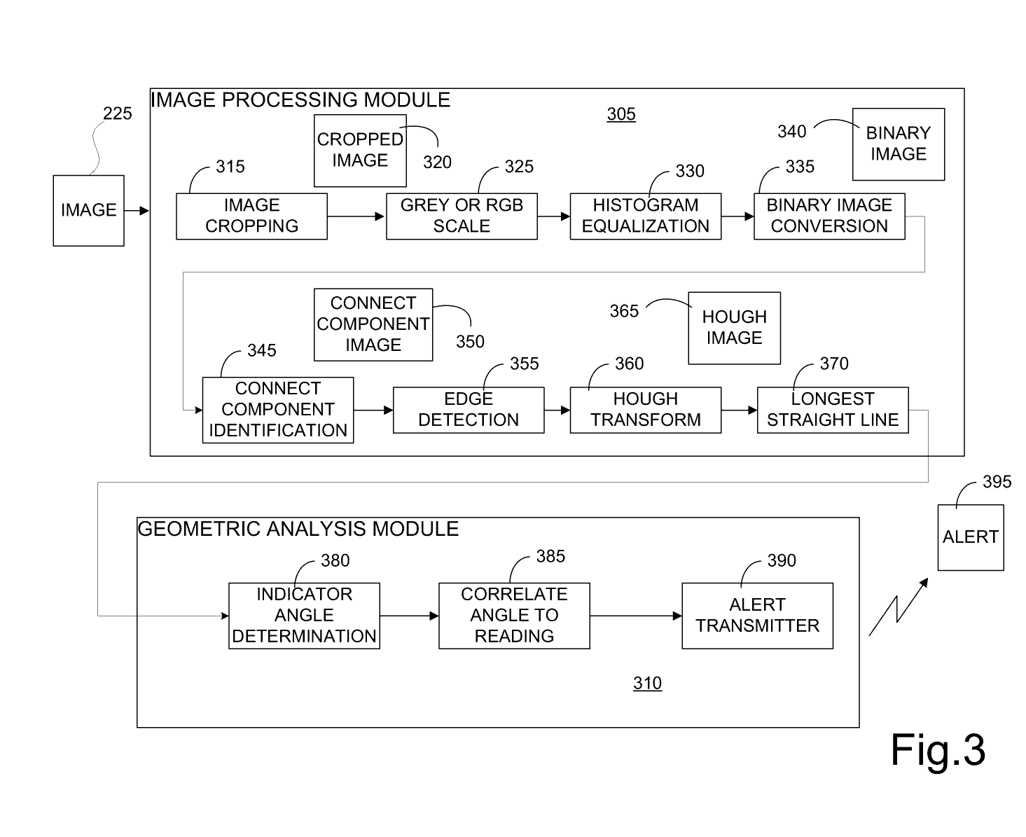

In embodiments, application service 120 may include an analog gauge monitoring system (to be described more fully below with references to FIG. 3). In general, client device 105 and application server 120 (beside having the analog gauge monitoring system) each may be a hardware computing device that may include one or more systems and/or applications for providing one or more services. Client device 105 and application server 120 each may include a processor, memory or computer readable storage medium, and a network interface. Additionally, client device 105 and application server 120 each be a single physical hardware device, or may be physically or logically connected with other network devices, so as to reside on one or more physical hardware devices. Furthermore, client device 105 and application server 120 each may be connected to, or otherwise associated with one or more data storage devices (not shown). The application server 120 may be any device capable of receiving and responding to requests from one or more client devices (e.g., client device 105) across a computer network (e.g., network 110) to provide one or more services client device 105.

In some embodiments, the application server 120 may provide IoT device services, and may be able to generate content such as text, graphics, audio and/or video to be transferred to client device 105, via a Web server (not shown) in the form of HTML, XML, and/or any other appropriate structured language. The handling of requests and responses, (e.g., requests for item information and the information provided in response), as well as the delivery of content between the IoT devices 101, the application server 120, and the client device 105 may be handled by the Web server (not shown). Furthermore, it should be understood that the application server 120 may not be required and the applications and software components discussed herein may be executed on any appropriate device or host machine. The application server 120 may include an operating system that may provide executable program instructions for the general administration and operation of application server 120, and may include a computer-readable medium storing instructions that, when executed by a processor of the application server 120, may allow the application server 120 to perform its intended functions. Suitable implementations for the operating system and general functionality of the servers are known or commercially available, and are readily implemented by persons having ordinary skill in the art, particularly in light of the disclosure herein.

In FIG. 1, only four devices 101, one GW 103, one client device 105, a single device database 115, and a single application server 120 are shown. According to various embodiments, any number of devices, any number of gateways, any number of client devices, any number of servers, and/or any number of databases (not shown) may be present. Additionally, in some embodiments, application server 120 and/or one or more databases may be virtual machines, and/or they may be provided as part of a cloud computing service. In various embodiments, application server 120 and one or more databases may reside on one physical hardware device, and/or may be otherwise fully integrated with one another. Thus, the depiction of the illustrative communications network 100 in FIG. 1 should be taken as being illustrative in nature, and not limited to the scope of the disclosure.

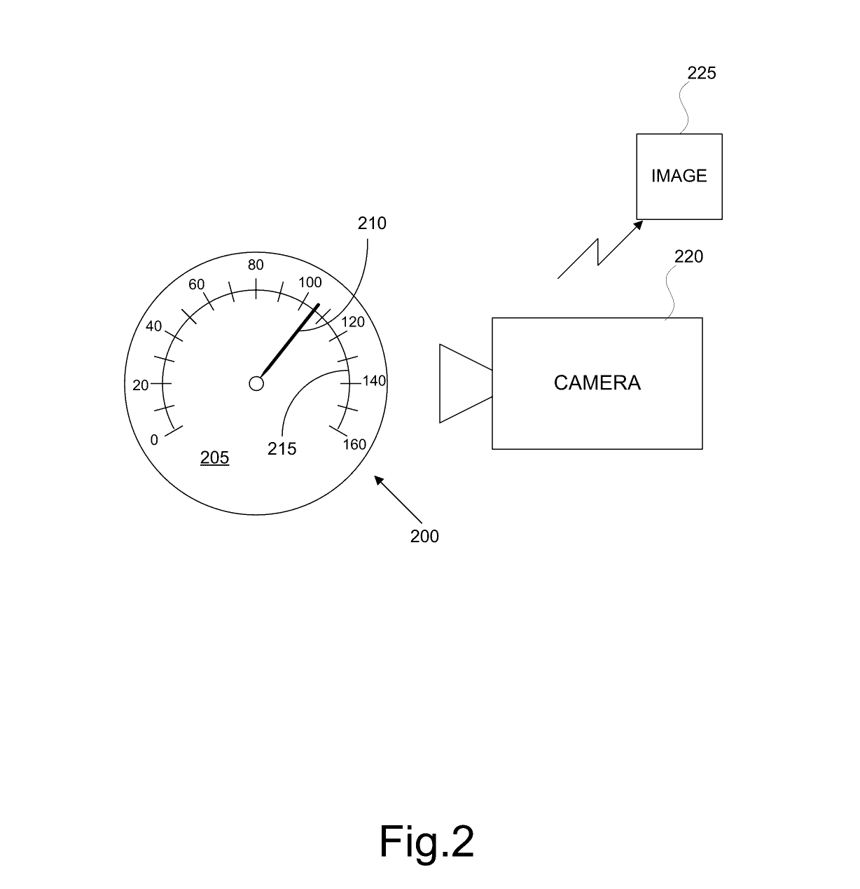

FIG. 2 is a diagram illustrating a conventional analog gauge 200 (which may be one of devices 101 of FIG. 1), sometimes referred to as an analog instrument meter with analog display, having a gauge face 205 with an analog value indicator 210 such as a needle or pointer that pivots about a calibrated scale 215 to provide an analog value indication. Gauge 200 may be any of a wide range of gauges used in science, industry, shipping, etc., in a wide range of situations including factories, mills, power plants, pipelines, etc. on various types of equipment, vehicles, vessels, etc. Calibrated scale 215 may be in any increments in reference to any units of measurement according to the application, and may indicate enumerated values or non-numerical measurement ranges (e.g., one or more acceptable “green” zones of performance and one or more undesirable “red” zones of performance).

Conventionally, analog gauge 200 is monitored by human visual observation which, for a gauge 200 in a remote or inconvenient location, can require significant time, effort, or expense and can even pose varying degrees exposure to or risk of injury. As described earlier, some analog gauges 200 may be replaced by gauges that function as IoT devices 101 that communicate gauge value information automatically. However, for the vast installed base of existing analog gauges 200, human visual observation is still required.

FIG. 2 also illustrates a digital camera 220 positioned to form a digital image 225 of gauge face 205 and to transmit or otherwise deliver image 225 to, for example, an application server 120 or another computing or processing device such that camera 220 operates in the manner of an IoT device 101. Digital image 225 will include imagery of analog value indicator 210 and calibrated scale 215 and will correspond to a visual observation of an analog value indication of analog gauge 200. It will be appreciated that image 225 may be transmitted from camera 220 by wired or wireless communication. Although the following description is directed to image 225 being transmitted to application server 120 operating in a manner described below, the described operations may be performed by any manner of other processing or computing devices or systems. For example, the image 225 may be transmitted to application server 120 via the GW 103, wherein one or more of the functions described with regard to FIG. 3 may be performed by the GW 103 while others are performed by the application server 120. For example, in some embodiments, the functions performed by the image processing module 305 may be performed by the GW 103 while the functions performed by the geometric analysis module 310 may be performed by the application server 120.

FIG. 3 is a block diagram of a gauge monitoring apparatus or system 300 that receives a digital image 225 of a gauge face 205 of a gauge 200 and provides monitoring of an analog value indication thereon. Monitoring system 300 may include image processing module 305, which distinguishes or identifies one or more gauge features in the image of gauge face 205, including one or more of analog value indicator 210 and calibrated scale 215. Monitoring system 300 may further include geometric analysis module 310, which determines geometric characteristics of the identified gauge features and a corresponding analog value indication of analog gauge 200. Image processing module 305 and geometric analysis module 310 may operate automatically by operation of application server 120, for example, upon receiving digital image 225. System 300 may provide image-based, non-intrusive, remote monitoring or reading of analog gauges, thus solving the problem of manual, in-person monitoring or service trips to remote areas to read gauges.

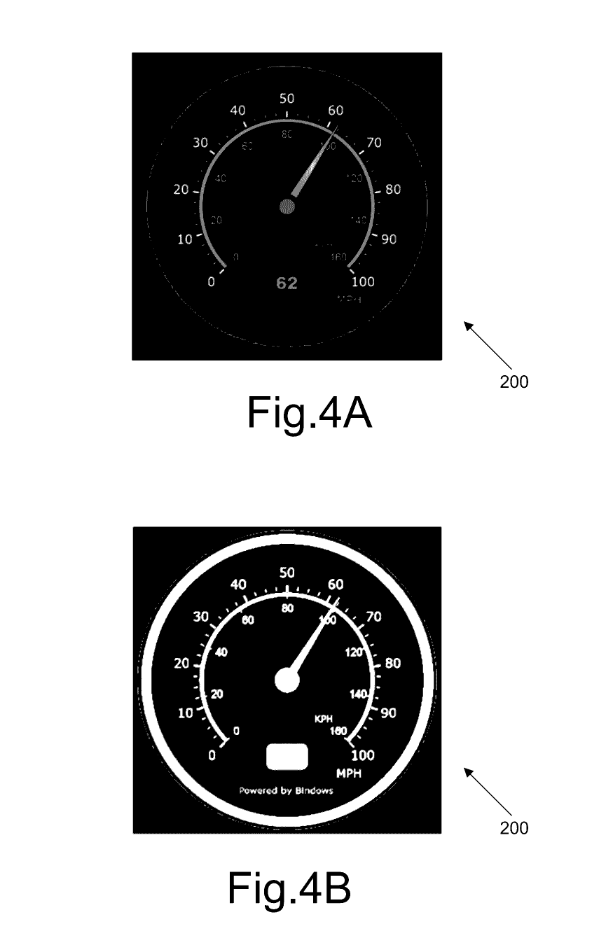

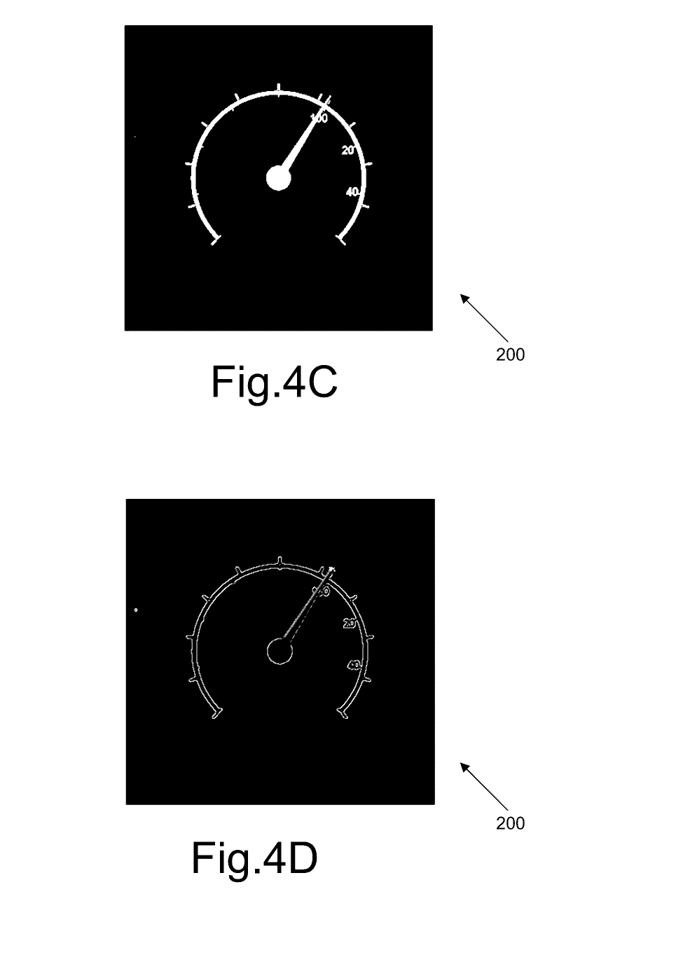

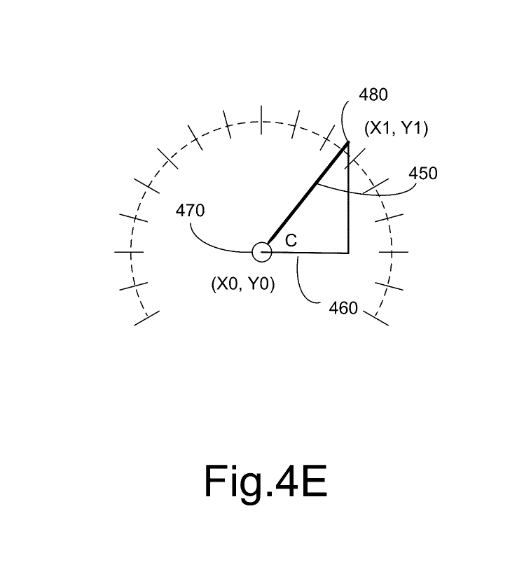

Image processing module 305 may receive digital image 225 of gauge face 205 from camera 220. Camera 220 may be or include a still or video digital camera and in one implementation may provide or transmit a new digital image on a periodic or cyclic basis. Image cropping 315 may crop digital image 225 substantially to gauge face 205 or its periphery, which may correspond to a cropping boundary that in one implementation may bound, intersect, or correspond to a maximal circular feature in image 225. A cropped image 320 may be provided to Grey/RGB scale determination 325, which may determine in a conventional manner whether cropped image 320, and by extension image 225, may be a grey-scale image or a red-green-blue (RGB) color-scale image. Based upon Grey/RGB scale determination 325, histogram equalization 330 may apply a corresponding grey-scale or color-scale histogram equalization to increase contrast in cropped image 320, and binary image conversion 335 generates a binary image 340 according to a predefined image threshold. In some embodiments where the image 225 is an RGB image, the grey/RGB scale determination 325 may include converting an RGB image into a grey-scale image for the grey-scale histogram equalization. In other embodiments, the color-scale histogram equalization may be performed directly on the RGB image without first converting the RGB image to a grey-scale image. FIG. 4A shows a sample 410 of a cropped image 320, and FIG. 4B shows a corresponding sample 420 of a binary image 340.

A connected components identification 345 may identify connected components in binary image 340 such as, for example, by any conventional manner of identifying connected components. In addition, connected components identification 345 may identify or select a predetermined number of the largest connected components (e.g., the two, three, or four largest connected components) according to the greatest numbers of linked or adjacent image elements or pixels that form a blob, and may generate a connected component image 350 with the predetermined number of the largest connected components from binary image 340. The large connected components in connected component image 350 may include analog value indicator 210 and calibrated scale 215. FIG. 4C shows a sample 430 of a connected component image 350. Edge detection 355 may be applied to connected component image 350 to identify the boundaries of the blob, and Hough transform 360 may be further applied to form a Hough transform image 365 to facilitate accurate identification or extraction of analog value indicator 210. FIG. 4D shows a sample 440 of a Hough transform image 365. An indicator identification 370 may be made of an identified analog value indicator 450 (FIG. 4E) as, for example, the longest identified straight-line component in Hough transform image 365. Geometric analysis module 310 may receive identified analog value indicator 450 and an indicator angle determination 380 may be applied to determine an angular inclination of analog value indicator 450.

An example of one implementation in which indicator angle determination 380 determines the angular inclination of analog value indicator 450 is described with reference to FIG. 4E, which is a simplified diagram showing analog value indicator 450 for purposes of illustrating a determination of angular inclination C. Analog value indicator 450 is shown in FIG. 4E with respect to a base orientation, such as a horizontal axis 460 and an indicator pivot point 470. Utilizing an X-Y Cartesian coordinate system, for example, pivot point 470 may correspond to a coordinate system origin (x0, y0), and analog value indicator 450 may point to or indicate an analog value indication 480 at a coordinate system location (x1, y1). The angle C of angular inclination of analog value indicator 450 may be determined as the inverse tangent of (y1-y0)/(x1-x0). The angle C of angular inclination of analog value indicator 450 may then be correlated 385 with one of multiple predetermined corresponding analog value indications for the gauge.

Predetermined analog value indications for a gauge corresponding to angular inclinations of an analog value indicator 450 may be determined in connection with an initialization of gauge monitoring apparatus or system 300 for a particular gauge. For example, angular inclinations of analog value indicator 450 may be correlated with particular indicated values or may be correlated with one or more threshold values above or below which an indicated value may correspond to a significant state in response to which a notification, alert, or alarm is sent for action. In the embodiment of FIG. 3, for example, geometric analysis module 310 may include an alert transmitter 390 that transmits an alert 395 if analog value indicator 450 indicates a value beyond a preselected threshold value, whether enumerated or not. It will be appreciated that the alert may be transmitted to a client device 105, for example, for a human observer or for an automated response.

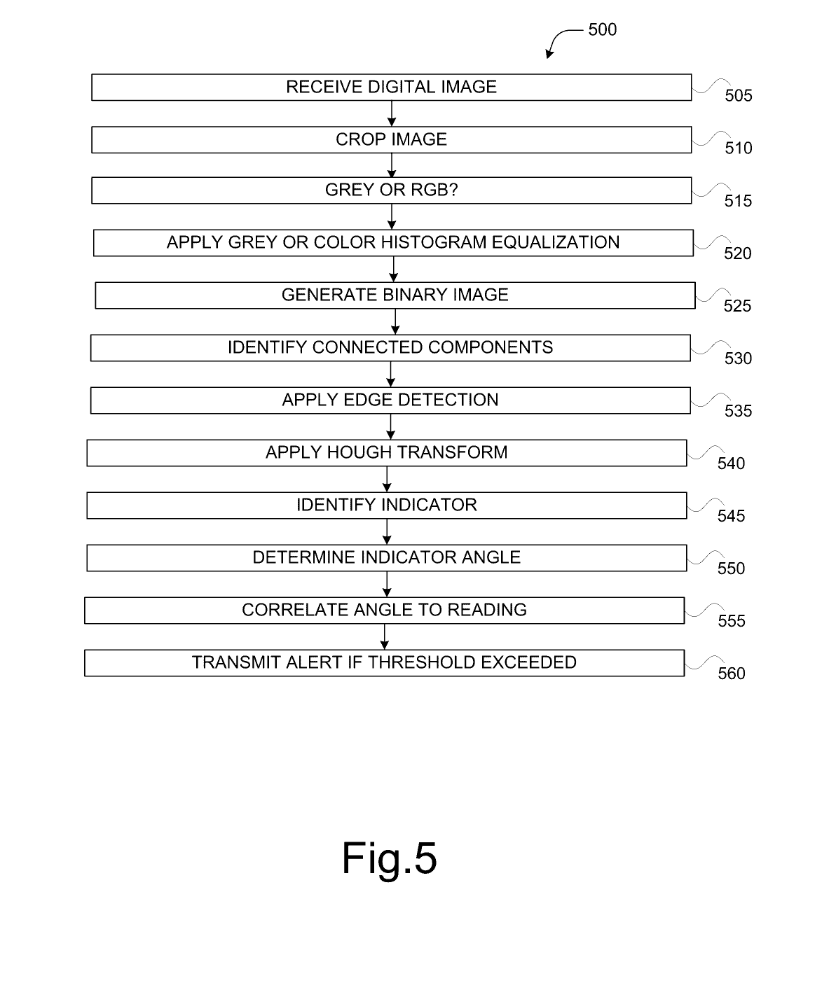

FIG. 5 is a flowchart illustrating an example process 500 of gauge monitoring. For illustrative purposes, the operations of process 500 will be described as being performed by application server 120 (FIG. 1). However, it should be noted that other computing devices may operate the process 500. While particular examples and orders of operations are illustrated in FIG. 5, in various embodiments, these operations may be re-ordered, separated into additional operations, combined, or omitted altogether.

Prior to operation of process 500, a gauge monitoring initialization may be performed for a selected gauge. Gauge monitoring initialization may include positioning a digital camera 220 to obtain and transmit images of a gauge face 205 and also determining predetermined analog value indications for the gauge corresponding to angular inclinations of its analog value indicator 210. For example, the angular inclinations of the analog value indicator 210 may be correlated with particular indicated values or may be correlated with one or more threshold values, enumerated or not, above or below which an indicated value may correspond to a significant state.

At operation 505, a digital image of a gauge face of a gauge may be received.

At operation 510, digital image may be cropped substantially to the gauge face or its periphery. The cropping may correspond to a cropping boundary that in one implementation bounds, intersects, or corresponds to a maximal circular feature in the image.

At operation 515, the cropped image may be determined to be of a grey (monochrome) scale or of a red-green-blue (RGB) color scale.

At operation 520, a grey-scale or color-scale histogram equalization may be applied to the cropped image according to whether it is of a grey-scale or a color-scale, respectively.

At operation 525, a binary image may be generated according to a predefined image threshold.

At operation 530, connected components may be identified in the binary image, and a predetermined number of largest connected components are identified.

At operation 535, edge detection may be applied to the predetermined number of largest connected components.

At operation 540, a Hough transform may be applied to form a Hough transform image.

At operation 545, an indicator identification may be made from the Hough transform image.

At operation 550, an indicator angle may be determined as an angular inclination of analog value indicator.

At operation 555, the angular inclination of analog value indicator may be correlated with an analog value indication or reading.

At operation 560, an alert may be transmitted if the analog value indication exceeds a preselected threshold value.

The above embodiments and implementations have been described with reference to analog gauge 200 having an analog value indicator 210 the moves along an arcuate calibrated scale 215. It will be appreciated, however, that other analog gauges have other analog value indicators, and that the systems and methods described are similarly applicable to such analog gauges. For example, some temperature gauges, or thermometers, include a linear scale along which a temperature reading is indicated by the level of a material, such as mercury. Similarly, some gauges include a pivoting indicator that by appearances travels along a linear scale. The systems and methods described above may be applied and adapted to such alternative analog gauges. For example, the operation of image processing module 305 would similarly provide identification of the analog value indicator, except that indicator identification 370 may be made with reference to a line component transverse to a longest identified straight-line component in Hough transform image 365.

Some non-limiting Examples are provided below.

Example 1 may include an apparatus for monitoring of a gauge, the apparatus comprising: one or more processors; an image processing module to be operated by at least one of the one or more processors to receive a digital image of a gauge to identify an analog value indicator and to form an indicator representation corresponding to the analog value indicator; and a geometric analysis module to be operated by at least one of the one or more processors to determine from the indicator representation a geometric characteristic corresponding to the analog value indicator and an indicated gauge value.

Example 2 may include the apparatus of example 1 and/or any other example disclosed herein in which the digital image includes a range of image values and the image processing module is to be operated by at least one of the one or more processors to generate from the digital image a binary image that includes the analog value indicator.

Example 3 may include the apparatus of example 2 and/or any other example disclosed herein in which the image processing module is to be operated by at least one of the one or more processors to generate from the binary image a connected component representation that includes the analog value indicator as one of plural connected components.

Example 4 may include the apparatus of example 3 and/or any other example disclosed herein in which and the image processing module is to be operated by at least one of the one or more processors to identify from the plural connected components a generally straight connected component that corresponds to the analog value indicator.

Example 5 may include the apparatus of example 3 and/or any other example disclosed herein in which the plural connected components are of different sizes and the image processing module is to be operated by at least one of the one or more processors to identify from the plural connected components a preselected number of the connected components of largest size.

Example 6 may include the apparatus of example 5 and/or any other example disclosed herein in which the image processing module is to be operated by at least one of the one or more processors to identify from the preselected number of the connected components of the largest size a generally straight connected component that corresponds to the analog value indicator.

Example 7 may include the apparatus of example 1 and/or any other example disclosed herein in which the analog value indicator pivots about an indicator axis and the geometric analysis module is to be operated by at least one of the one or more processors to determine from the indicator representation an angular orientation of the analog value indicator indicative of the indicated gauge value.

Example 8 may include the apparatus of example 1 and/or any other example disclosed herein in which the geometric analysis module is to be operated by at least one of the one or more processors to provide the indicated gauge value to a recipient.

Example 9 may include the apparatus of example 1 and/or any other example disclosed herein further comprising a digital camera to provide the digital image.

Example 10 may include the apparatus of example 9 and/or any other example disclosed herein in which the digital camera and at least one of the one or more processors are positioned together in proximity to the gauge.

Example 11 may include an apparatus for monitoring of a gauge, the apparatus comprising: image processing means for receiving a digital image of a gauge to identify an analog value indicator and to form an indicator representation corresponding to the analog value indicator; and geometric analysis means for determining from the indicator representation a geometric characteristic corresponding to the analog value indicator and an indicated gauge value.

Example 12 may include the apparatus of example 11 and/or any other example disclosed herein in which the digital image includes a range of image values and the image processing means generates from the digital image a binary image that includes the analog value indicator.

Example 13 may include the apparatus of example 11 and/or any other example disclosed herein in which the image processing means generates from the binary image a connected component representation that includes the analog value indicator as one of plural connected components.

Example 14 may include the apparatus of example 13 and/or any other example disclosed herein in which and the image processing means identifies from the plural connected components a generally straight connected component that corresponds to the analog value indicator.

Example 15 may include the apparatus of example 13 and/or any other example disclosed herein in which the plural connected components are of different sizes and the image processing means identifies from the plural connected components a preselected number of the connected components of largest size.

Example 16 may include the apparatus of example 15 and/or any other example disclosed herein in which the image processing means identifies from the preselected number of the connected components of the largest size a generally straight connected component that corresponds to the analog value indicator.

Example 17 may include the apparatus of example 11 and/or any other example disclosed herein in which the analog value indicator pivots about an indicator axis and the geometric analysis means determines from the indicator representation an angular orientation of the analog value indicator indicative of the indicated gauge value.

Example 18 may include the apparatus of example 11 and/or any other example disclosed herein in which the geometric analysis means provides the indicated gauge value to a recipient.

Example 19 may include the apparatus of example 11 and/or any other example disclosed herein further comprising a digital camera to provide the digital image.

Example 20 may include a method for monitoring of a gauge, the method comprising: receiving, by a computing device, a digital image of a gauge having an analog value indicator; forming, by the computing device, an indicator representation corresponding to the analog value indicator; and determining, by the computing device, from the indicator representation a geometric characteristic corresponding to the analog value indicator and an indicated gauge value.

Example 21 may include the method of example 20 and/or any other example disclosed herein in which the digital image includes a range of image values and the method further includes generating from the digital image a binary image that includes the analog value indicator.

Example 22 may include the method of example 21 and/or any other example disclosed herein further including generating, by the computing device, from the binary image a connected component representation that includes the analog value indicator as one of plural connected components.

Example 23 may include the method of example 22 and/or any other example disclosed herein further including identifying, by the computing device, from the plural connected components a generally straight connected component that corresponds to the analog value indicator.

Example 24 may include the method of example 22 and/or any other example disclosed herein in which the plural connected components are of different sizes and the method further includes identifying, by the computing device, from the plural connected components a preselected number of the connected components of largest size.

Example 25 may include the method of example 24 and/or any other example disclosed herein further including identifying, by the computing device, from the preselected number of the connected components of the largest size a generally straight connected component that corresponds to the analog value indicator.

Example 26 may include the method of example 20 and/or any other example disclosed herein in which the analog value indicator pivots about an indicator axis and the method further includes determining, by the computing device, from the indicator representation an angular orientation of the analog value indicator indicative of the indicated gauge value.

Example 27 may include the method of example 20 and/or any other example disclosed herein further including providing, by the computing device, the indicated gauge value to a recipient.

Example 28 may include at least one computer-readable medium including instructions to cause a computing device, in response to execution of the instructions by the computing device, to perform the method of examples 20-27 and/or any other example disclosed herein. The at least one computer-readable medium may be a non-transitory computer readable medium.

Example 29 may include at least one computer-readable medium including instructions to cause a device, in response to execution of the instructions by the device, to: receive a digital image of a gauge having an analog value indicator; form an indicator representation corresponding to the analog value indicator; and determine from the indicator representation a geometric characteristic corresponding to the analog value indicator and an indicated gauge value. The at least one computer-readable medium may be a non-transitory computer readable medium.

Example 30 may include the at least one computer-readable medium of example 29 and/or any other example disclosed herein, wherein the digital image includes a range of image values and the instructions further cause the device, in response to execution of the instructions by the device, to generate from the digital image a binary image that includes the analog value indicator.

Example 31 may include the at least one computer-readable medium of example 30 and/or any other example disclosed herein, wherein the instructions further cause the device, in response to execution of the instructions by the device, to generate from the binary image a connected component representation that includes the analog value indicator as one of plural connected components.

Example 32 may include the at least one computer-readable medium of example 31 and/or any other example disclosed herein, wherein the instructions further cause the device, in response to execution of the instructions by the device, to identify from the plural connected components a generally straight connected component that corresponds to the analog value indicator.

Example 33 may include the at least one computer-readable medium of example 31 and/or any other example disclosed herein, wherein the plural connected components are of different sizes and the instructions further cause the device, in response to execution of the instructions by the device, to identify from the plural connected components a preselected number of the connected components of largest size.

Example 34 may include the at least one computer-readable medium of example 33 and/or any other example disclosed herein, wherein the instructions further cause the device, in response to execution of the instructions by the device, to identify from the preselected number of the connected components of the largest size a generally straight connected component that corresponds to the analog value indicator.

Example 35 may include the at least one computer-readable medium of example 29, and/or any other example disclosed herein wherein the analog value indicator pivots about an indicator axis and the instructions further cause the device, in response to execution of the instructions by the device, to determine from the indicator representation an angular orientation of the analog value indicator indicative of the indicated gauge value.

Example 36 may include the at least one computer-readable medium of example 29 and/or any other example disclosed herein, wherein the instructions further cause the device, in response to execution of the instructions by the device, to provide the indicated gauge value to a recipient.

Example 37 may include the a system for monitoring of a gauge, the system comprises: an analog gauge comprising an analog value indicator; a digital camera to capture a digital image of a gauge; and a computing devices communicatively coupled with the digital camera, the computing device comprising: one or more processors; an image processing module to be operated by at least one of the one or more processors to receive the digital image of the gauge from the digital camera; identify the analog value indicator; and form an indicator representation corresponding to the analog value indicator; and a geometric analysis module to be operated by at least one of the one or more processors to determine from the indicator representation a geometric characteristic corresponding to the analog value indicator and an indicated gauge value.

Example 38 may include the system of example 37 and/or any other example disclosed herein in which the digital image includes a range of image values and the image processing module is to be operated by at least one of the one or more processors to generate from the digital image a binary image that includes the analog value indicator.

Example 39 may include the system of example 38 and/or any other example disclosed herein in which the image processing module is to be operated by at least one of the one or more processors to generate from the binary image a connected component representation that includes the analog value indicator as one of plural connected components.

Example 40 may include the system of example 39 and/or any other example disclosed herein in which and the image processing module is to be operated by at least one of the one or more processors to identify from the plural connected components a generally straight connected component that corresponds to the analog value indicator.

Example 41 may include the system of example 39 and/or any other example disclosed herein in which the plural connected components are of different sizes and the image processing module is to be operated by at least one of the one or more processors to identify from the plural connected components a preselected number of the connected components of largest size.

Example 42 may include the system of example 41 and/or any other example disclosed herein in which the image processing module is to be operated by at least one of the one or more processors to identify from the preselected number of the connected components of the largest size a generally straight connected component that corresponds to the analog value indicator.

Example 43 may include the system of example 37 and/or any other example disclosed herein in which the analog value indicator pivots about an indicator axis and the geometric analysis module is to be operated by at least one of the one or more processors to determine from the indicator representation an angular orientation of the analog value indicator indicative of the indicated gauge value.

Example 44 may include the system of example 37 and/or any other example disclosed herein in which the geometric analysis module is to be operated by at least one of the one or more processors to provide the indicated gauge value to a recipient.

Example 45 may include the system of example 37 and/or any other example disclosed herein, wherein the digital camera embedded with the computing device or separate from the computing device.

Example 46 may include the system of example 37 and/or any other example disclosed herein in which the digital camera and the computing device are positioned together in proximity to the gauge.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, limited only by the claims.

What is claimed:

1. An apparatus for monitoring of a gauge, the apparatus comprising:
one or more processors;
an image processing module to be operated by at least one of the one or more processors to receive a digital image of a gauge to identify an analog value indicator and to form an indicator representation corresponding to the analog value indicator; and
a geometric analysis module to be operated by at least one of the one or more processors to determine from the indicator representation a geometric characteristic corresponding to the analog value indicator and an indicated gauge value.

2. The apparatus of claim 1 in which the digital image includes a range of image values and the image processing module is to be operated by at least one of the one or more processors to generate from the digital image a binary image that includes the analog value indicator.

3. The apparatus of claim 2 in which the image processing module is to be operated by at least one of the one or more processors to generate from the binary image a connected component representation that includes the analog value indicator as one of plural connected components.

4. The apparatus of claim 3 in which and the image processing module is to be operated by at least one of the one or more processors to identify from the plural connected components a generally straight connected component that corresponds to the analog value indicator.

5. The apparatus of claim 3 in which the plural connected components are of different sizes and the image processing module is to be operated by at least one of the one or more processors to identify from the plural connected components a preselected number of the connected components of largest size.

6. The apparatus of claim 5 in which the image processing module is to be operated by at least one of the one or more processors to identify from the preselected number of the connected components of the largest size a generally straight connected component that corresponds to the analog value indicator.

7. The apparatus of claim 1 in which the analog value indicator pivots about an indicator axis and the geometric analysis module is to be operated by at least one of the one or more processors to determine from the indicator representation an angular orientation of the analog value indicator indicative of the indicated gauge value.

8. The apparatus of claim 1 in which the geometric analysis module is to be operated by at least one of the one or more processors to provide the indicated gauge value to a recipient.

9. The apparatus of claim 1 further comprising a digital camera to provide the digital image.

10. The apparatus of claim 9 in which the digital camera and at least one of the one or more processors are positioned together in proximity to the gauge.

11. A method for monitoring of a gauge, the method comprising:
receiving, by a computing device, a digital image of a gauge having an analog value indicator;
forming, by the computing device, an indicator representation corresponding to the analog value indicator; and
determining, by the computing device, from the indicator representation a geometric characteristic corresponding to the analog value indicator and an indicated gauge value.

12. The method of claim 11 in which the digital image includes a range of image values and the method further includes generating from the digital image a binary image that includes the analog value indicator.

13. The method of claim 11 further including generating, by the computing device, from the binary image a connected component representation that includes the analog value indicator as one of plural connected components.

14. The method of claim 13 further including identifying, by the computing device, from the plural connected components a generally straight connected component that corresponds to the analog value indicator.

15. The method of claim 13 in which the plural connected components are of different sizes and the method further includes identifying, by the computing device, from the plural connected components a preselected number of the connected components of largest size.

16. The method of claim 15 further including identifying, by the computing device, from the preselected number of the connected components of the largest size a generally straight connected component that corresponds to the analog value indicator.

17. The method of claim 11 in which the analog value indicator pivots about an indicator axis and the method further includes determining, by the computing device, from the indicator representation an angular orientation of the analog value indicator indicative of the indicated gauge value.

18. The method of claim 11 further including providing, by the computing device, the indicated gauge value to a recipient.

19. At least one non-transitory computer-readable medium including instructions to cause a device, in response to execution of the instructions by the device, to:
receive a digital image of a gauge having an analog value indicator;
form an indicator representation corresponding to the analog value indicator; and
determine from the indicator representation a geometric characteristic corresponding to the analog value indicator and an indicated gauge value.

20. The at least one non-transitory computer-readable medium of claim 19 wherein the digital image includes a range of image values and the instructions further cause the device, in response to execution of the instructions by the device, to generate from the digital image a binary image that includes the analog value indicator.

21. The at least one non-transitory computer-readable medium of claim 20 wherein the instructions further cause the device, in response to execution of the instructions by the device, to generate from the binary image a connected component representation that includes the analog value indicator as one of plural connected components.

22. The at least one non-transitory computer-readable medium of claim 21 wherein the instructions further cause the device, in response to execution of the instructions by the device, to identify from the plural connected components a generally straight connected component that corresponds to the analog value indicator.

23. The at least one non-transitory computer-readable medium of claim 21 wherein the plural connected components are of different sizes and the instructions further cause the device, in response to execution of the instructions by the device, to identify from the plural connected components a preselected number of the connected components of largest size.

24. The at least one non-transitory computer-readable medium of claim 23 wherein the instructions further cause the device, in response to execution of the instructions by the device, to identify from the preselected number of the connected components of the largest size a generally straight connected component that corresponds to the analog value indicator.

25. The at least one non-transitory computer-readable medium of claim 19 wherein the analog value indicator pivots about an indicator axis and the instructions further cause the device, in response to execution of the instructions by the device, to determine from the indicator representation an angular orientation of the analog value indicator indicative of the indicated gauge value.

26. The at least one non-transitory computer-readable medium of claim 19 wherein the instructions further cause the device, in response to execution of the instructions by the device, to provide the indicated gauge value to a recipient.
